(19) United States
(12) Patent Application Publication
(10) Pub. No.: US 2020/0380512 A1
(43) Pub. Date: Dec. 3, 2020

(54) METHODS AND APPARATUS FOR CONTROLLING PIPELINE TRANSFERS UTILIZING A BLOCKCHAIN

(71) Applicant: The Energy Authority, Inc., Jacksonville, FL (US)

(72) Inventors: Joseph A. Witkowski, Jacksonville, FL (US); Michelle Straley, Jacksonville, FL (US); Robert Trinnear, Jacksonville, FL (US)

(73) Assignee: The Energy Authority, Inc., Jacksonville, FL (US)

(21) Appl. No.: 16/886,011

(22) Filed: May 28, 2020

Related U.S. Application Data
(60) Provisional application No. 62/853,516, filed on May 28, 2019.

(51) Int. Cl. G06Q 20/40; H04L 9/06; G06Q 20/38; H04L 9/08; G06Q 50/06; H04L 29/06

(52) U.S. Cl. CPC G06Q 20/401; H04L 9/0637; G06Q 20/382; G06Q 2220/00; G06Q 50/06; H04L 63/0442; H04L 2209/38; H04L 9/0827

(57) ABSTRACT

Method and apparatus for implementing a Blockchain that tracks a transfer of natural gas from a seller to a buyer. The Blockchain is in logical communication with Off-Block controllers and logical systems and storage. This may allow for faster reconciliation between the parties due to cuts to the natural gas transfer, as all parties can be in agreement on relevant facts to the transfer. The Blockchain may also be in logical connection with one or more pipelines involved in the transfer of gas from the seller to the buyer.

### CROSS-REFERENCE TO RELATED APPLICATIONS

This application claims priority to U.S. Provisional Patent Application Ser. No. 62/853,516, entitled Methods and Apparatus for Controlling Pipeline Transfers Utilizing a Blockchain, filed on May 28, 2019. The contents of that provisional patent application are relied upon and incorporated by reference herein in their entirety.

### FIELD OF THE DISCLOSURE

The present disclosure relates to methods and apparatus for controlling and documenting a transfer of a material, such as a hydrocarbon, via a pipeline. Specifically, embodiments include methods and apparatus to track fulfillment a series of actions relating to a transfer of natural gas via pipeline, wherein the series of actions require participation by a plurality of users that can use a blockchain as a single source of truth in the transfer.

### BACKGROUND OF THE DISCLOSURE

Presently, natural gas transfers are conducted via disparate trading and mechanisms that are inefficient and error-prone. Parties to a transaction enter data separately, so data entry errors are common, particularly for trades with physical deliveries and volume adjustments. Pipeline and trading systems are not linked via automation and volume updates to trade records rely upon manual entry

Back office personnel are not typically aware of an error, or discrepancies of records maintained by disparate parties, until receipt of invoices for settlement. Since settlement is conducted on a monthly basis, discrepancies require investigation into events that may have occurred several weeks in the past, or longer. Data entry errors increase with higher volumes of trades, multiple counterparties, and multiple pipelines.

In addition, pipelines are controlled independent of trading mechanisms and often an actual transfer of gas may not match an amount specified in a transacted trade. Moreover, disparate trading systems utilized by various parties to a trade, and subsequent transfer of gas, may have different records that must be reconciled by manual intervention.

Apparatus and methods of interacting with the apparatus are therefore needed to allow more efficient trades of natural gas.

### SUMMARY OF THE DISCLOSURE

Accordingly, the present invention provides apparatus and methods for initiating a transfer of an amount of natural gas via operation of a pipeline, facilitating an actual transfer of the amount of traded natural gas from a source to a destination, accurately tracking an amount of natural gas actually transferred and when, and conducting reconciliation of obligations and rights based upon the amount of natural gas actually transferred. The methods and apparatus provide for regulated access to trade documents and safeguards against data discrepancies—including any intentional or unintentional modification of trade related records and centralization of records currently stored in disparate locations on disparate systems.

The present invention utilizes blockchain technology to provide Participants to a natural gas-related trade with centrally accessible, immutable, certified records of actions that have transpired; scheduled actions; identification of a party associated with an action; peripheral details related to an action; smart contracts memorializing obligations entered into the correspond with an action; and delineation of Blockchain shared data and off-Blockchain proprietary data, as well as mechanisms and methods for linking Blockchain Shared data and Off-Blockchain proprietary data.

In the following sections, detailed descriptions of examples and methods of the invention will be given. The description of both preferred and alternative examples though thorough are exemplary only, and it is understood to those skilled in the art that variations, modifications and alterations may be apparent. It is therefore to be understood that the examples do not limit the broadness of the aspects of the underlying invention as defined by the claims.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates a flow diagram showing an exemplary method of conducting a natural-gas transaction between two traders with reference to and by substantiating a Trading Blockchain.

FIG. 2A illustrates an exemplary Blockchain system of apparatus with nodes controlling natural gas pipelines or other transportation apparatus or storage.

FIG. 2B illustrates apparatus and data storage that may be included in some implementations of the present invention.

FIG. 3 illustrates an exemplary embodiment of a subset of Blocks of a Trading Blockchain.

FIG. 4 illustrates a relational block diagram of some exemplary embodiments of the present invention.

FIGS. 5A-5G illustrate exemplary aspects of a graphical user interface deployable in connection with the present invention.

FIG. 6 illustrates a controller that may be used to implement aspects of the present disclosure including executable software.

According to the present disclosure, natural-gas trades are executed using a Blockchain as a single source of truth in the transaction. This may prevent inefficient, inaccurate, and difficult reconciliation subsequent to the transaction.

Exemplary embodiments of this present invention may occur on one or more Blockchains, in which at least some steps in a natural-gas trade will be memorialized as Blocks on the Blockchain. As stated below, a Blockchain is generally a distributed, linked list. Accordingly, the effectiveness of the present invention may vary depending upon the identity of the recipients of the linked list. For example, while the Blockchain must, at a minimum, be distributed to the relevant Participants to the natural-gas trade, the Blockchain may also be distributed to: a consortium, a marketplace, a set of regulators, a set of market participants, or another set of relevant parties.

The reason for this is that the immutability of a Blockchain can depend on a set of Participants affirming the Blocks on the chain. Accordingly, exemplary embodiments may involve distribution of the Blockchain to a marketplace (i.e., a subset of traders, some of whom will not be participants to the trade memorialized by a given Block, and in some embodiments, marketplace administration). Other embodiments may involve distribution of the Blockchain to a consortium (i.e., a group of trusted entities who can certify the addition of Blocks). And still other embodiments may contemplate including regulators in the distribution.

Users of this invention may not wish to give sensitive data to other traders in the marketplace who may be competitive with the users. Accordingly, exemplary embodiments of the present invention may include one or more security features, such as cryptographic controls over the contents of a Block and the use of off-Block data.

### Glossary

“Blockchain,” as used herein, refers to a shared electronic ledger, such as an append-only, computerized, linked data record known to those in the art as a blockchain, which is transmitted to, and stored upon, a plurality of computerized nodes operated by a plurality of Participants upon an appending action. As used herein, Blocks (which are the constituent elements of a Blockchain) on the Blockchain are generally numbered as Bₙ, where n is an integer. Where n is not assigned a specific integer, Bₙ is presumed to be an arbitrary Block on the Blockchain; if n is a specific integer, then Bₙ is presumed to be a corresponding Block (e.g., B₁ is the first Block on the Blockchain). Unless otherwise indicated, Bₙ occurs sequentially before Bₙ₊₁. Where Bₙ and Bₘ are described separately, m is presumed to be an integer not equal to m. A Block may be time stamped and secured and bound to each other using cryptographic principles (e.g., chain). A Blockchain may begin with a “Genesis Block.” A “Trading Blockchain” is a Blockchain used for the trading of natural gas.

“ETRM,” as used herein, refers to an energy trading risk-management system.

“Natural Gas,” as used herein, refers to a hydrocarbon in a form conducive to transport and delivery via a pipeline.

“Nomination,” as used herein, refers to the notification to put into effect a contract or a part of a contract, such as gas flow nomination from a shipper to advise the pipeline owner of the amount of gas it wishes to transport or hold in storage on a given day, or to the scheduling of a transfer of natural gas.

“Off-Block,” as used herein, means data or apparatus that are not accessible to a Person based on the Person's status as a Participant.

“Participant,” as used herein, refers to a Person authorized to access a Blockchain.

“Person,” as used herein, refers to a legal entity capable of ownership of an asset or being bound to execute an action.

“Pipeline,” as used herein, refers to a conduit for transportation of natural gas. Aspects of a pipeline may include piping, associated valves, pumps, flow meters, controllers, sensors, and other equipment used in a transfer of Natural Gas from a first point to a second point.

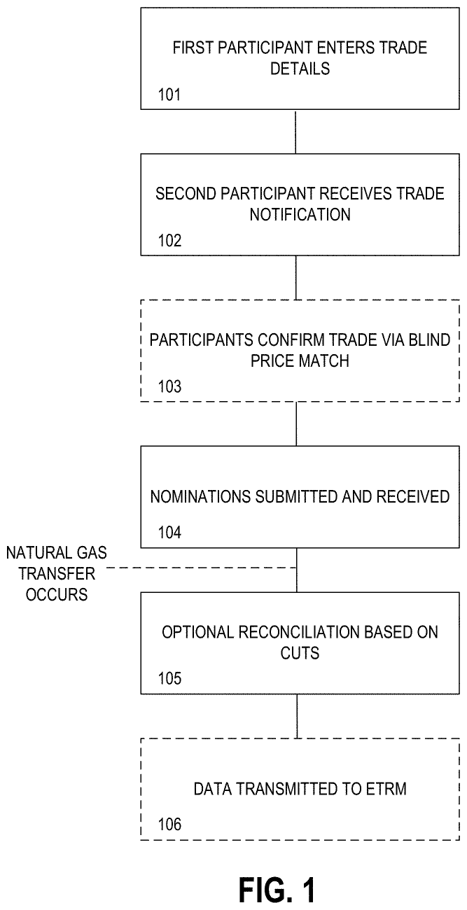

Referring now to FIG. 1, an exemplary method of conducting a natural-gas transaction between two traders with reference to and by substantiating a Trading Blockchain. At a point prior to step 101, it is assumed that a Trading Blockchain has been initialized with a Genesis Block. As stated above, the Trading Blockchain may be associated solely with the instant natural-gas transaction. The Trading Blockchain may also be associated with the two traders, a subset of a marketplace including one or both of the traders, the entire marketplace, a regulatory scheme, or any other similar suitable scheme. In embodiments in which the Trading Blockchain is associated with more trades than the instant natural-gas transaction, it is important to associate the transaction with a unique identifier. In some embodiments, this unique identifier may be visible to all recipients of the Trading Blockchain. In other embodiments, the unique identifier, like other data, may be hidden from those lacking the appropriate decryption keys.

At step 101, the first trader enters into a system (such as an ETRM system, Blockchain interface, etc.) details about the trade. These details may include a price the first trader is willing to pay or accept (where the price may be in absolute terms, or in terms of price per unit of natural gas), a time or date of the trade (especially useful in futures trading), a volume of natural gas, a desired route of natural gas transfer (or a number of stops associated therewith), or other useful information about the prospective trade. Some or all of these details may be placed onto a first Block on the Trading Blockchain. Note that as used in this context, “first Block” does not necessarily mean the first Block actually on the Trading Blockchain (i.e., the Genesis Block), but rather the first Block on the Trading Blockchain that is correlated with the identification number associated with the specific natural-gas trade at issue.

These details may be placed in absolute terms, allowing any of the Participants to view the details. In some embodiments, however, these details may be entered into the Block using a cryptographic scheme, such as a public-private key scheme. This would allow only those Participants with the appropriate decryption keys to view the details, while allowing all Participants to view affirming information about the Block, such as its hash, as may be necessary to ratify the Block and ensure immutability down the chain. Some or all data entered onto Blocks in this method may similarly take advantage of known cryptographic methods.

In some embodiments, the details of the trade may be entered by the first trader without reference to an already-known trade. For example, the first trader may enter parameters of a type of trade to which he would generally be amenable, which would allow the second trader specifically (or other traders) to view the potential trade and make an offer on similar or identical terms to those parameters. In other embodiments, the first and second traders may have already reached an agreement on the type of trade and wish to use the Trading Blockchain to verify the trade.

Accordingly, at step 102, the second trader may receive a notification on a smart device application, an ETRM system, or other means. The second trader may accept, decline, counter, or ignore this notification. This too may be entered by the second trader on the same or a different Block as the details entered by the first trader.

In some embodiments, a regulator, marketplace administrator, or global administrator may add Blocks to the Trading Blockchain to show regulatory events. However, in exemplary embodiments, the administrator does not exert a centralized control over the process. This administrator may update coding, review trades, and the like.

At step 103, if the trade is to be consummated, the parties agree to its terms. In some embodiments, this is done via a blind price match. For example, one or more trades may be visible in an ETRM system or on another Trading Blockchain viewing platform; in some embodiments, this may be done after decoupling of the identity of the trader from the specific proposed trade. In some regulatory frameworks, it may be desirable to select the trade based purely on its terms, rather than on the identity of its participants. Information about this agreement or the blind price matching may be included as a Block on the Trading Blockchain.

At step 104, one or more Nominations are submitted to and received at one or more pipelines involved in the trade. In some embodiments, one or both of the first and second traders, a pipeline manager, a trade observer, or a regulator may submit the Nominations to the pipeline. The Nominations may also be included as an additional Block on the Trading Blockchain to allow relevant stakeholders to view the terms of the Nominations.

In some embodiments, an apparatus implementing the present invention may itself be connected to the pipeline and capable of directly facilitating the trade.

Additionally, in some embodiments, a smart contract may be used in conjunction with the Trading Blockchain to execute the terms of the trade. For example, after notification from the pipeline that the trade has been executed, the compensation for the trade may be transferred using the Trading Blockchain from the buyer to the seller. This may be done, for instance, by temporarily transferring the relevant amount of money into an escrow.

At step 105, after the pipeline has accommodated the trade, reconciliation may occur through a reconciliation workflow by using a transfer report from the pipeline detailing the amount of gas actually transferred and other relevant data. Reconciliation may be necessary due to a Cut. A Cut may refer to a situation in which more or less natural gas was transferred from the pipeline than was ordered via the Nomination. In this situation, the first and second traders will ideally have contractual recourse. As a non-limiting example, suppose the first and second traders agreed that the first trader would sell one barrel of crude oil for $12 to the second trader. However, after the Nomination and transfer, the second trader has obtained 1.1 barrels of crude oil. The reconciliation process would require the second trader to give an extra $1.20 to the first trader.

In the existing natural-gas marketplace, this process could take months. Presently, after both traders input the trade details into an ETRM system, their respective middle office groups confirm these details. This requires duplication of effort which could lead to discrepancies. Additionally, after the trade, the pipelines adjust volumes, as necessary, and both traders adjust the trade volumes in their respective ETRMs (which could involve both manual entry and duplication—again, potential sources of error). Finally, the traders' respective back offices confirm invoice and trade details, at which point they may discover any discrepancies. These data discrepancies may then need to be investigated, which may take a month or longer. The balance of this reconciliation process is that even a minor discrepancy in agreed-upon price, pipeline volume, etc., may cause the parties to embark upon a month-long process to determine the appropriate prices and receive the appropriate money.

In contrast, step 105 allows quick, mutually agreeable reconciliation based upon the cuts. The parties to the trade, including the pipeline, can all report to and view data on the Trading Blockchain. Since the Trading Blockchain acts as a single, certified, mutually agreed-upon source of truth, the parties can quickly view the original terms of the trade, view any discrepancies, and settle up quickly, instead of needing to wait a month or more.

In embodiments utilizing a smart contract, the smart contract itself may be operable to re-transfer from an escrow an amount of money appropriate to achieve reconciliation.

Finally, at step 106, information about the on-Blockchain data (including the observed discrepancies, settlement amounts, etc.) may be transmitted to an individual trader's ETRM system. By having off-Blockchain data like this, parties can, in exemplary embodiments, reserve the Trading Blockchain use for data that is useful to all parties involved (such as the terms of the trading agreement and observed discrepancies), while keeping more confidential or proprietary information off the Blockchain. Moreover, this particular implementation can be more optimized in some deployments, as some general, marketplace Blockchain solutions are not especially optimized. Since many current Blockchain solutions have performance issues for large amounts of data, changing the proportion of data stored on the Blockchain compared to off-Blockchain data may produce performance enhancements.

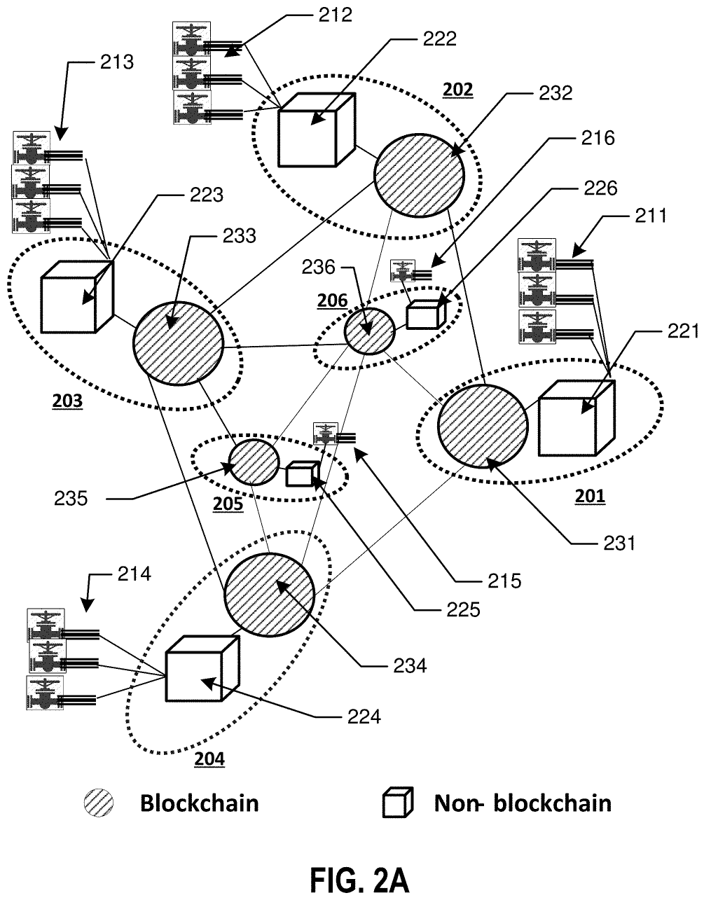

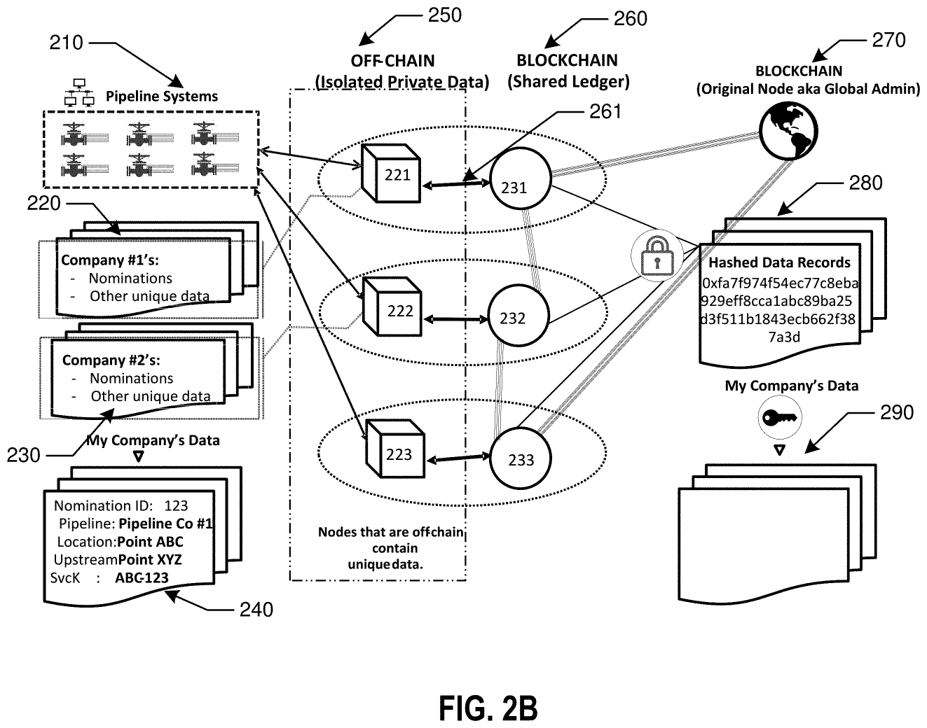

Referring now to FIG. 2A, an illustration provides an exemplary diagram of interactions with multiple Participant nodes 201-206. Each node may include Blockchain aspects 231-234 that communicate with other Blockchain nodes 201-206 and non-Blockchain, or Off-Block aspects 221-226 that may or may not communicate with other nodes 201-206. Off-Block aspects 221-226 within the node may include local controllers, data processing equipment, machinery, equipment, storage, or other devices and data storage vehicles.

In some embodiments, Off-Block aspects 221-226 may include control mechanisms for implementing a transfer of natural gas. Control mechanisms may include one or more Pipelines 211-216, volume meters, storage facilities and the like.

In some embodiments, a Pipeline 211-216 may be controlled or otherwise influenced by logical communication with Blockchain aspects 231-234. In such embodiments, the Blockchain aspects 231-234 may memorialize instructions to a pipeline and actual actions taken by a pipeline 211-216. These instructions and actions may be conveyed to the Blockchain via control mechanisms through the Off-Block aspects 221-226 and the Blockchain aspects 231-234.

Referring now to FIG. 2B, additional aspects and relationships between components of a system according to the present invention are illustrated. Off-Block apparatus 250, such as controllers and/or control systems 221-223 may interact with pipeline systems 210 and accomplish one or both of: control a transfer of natural gas; and memorialize a transfer of natural gas. Nodes 221-223 that are Off-Chain are capable of containing unique data. The controllers and/or control systems 221-223 may in turn receive instruction from a Blockchain nodes 231-233 and report actual parameters of a transfer of natural gas consummated via the pipeline systems 210.

The Blockchain Original Node 270 may be maintained by a Global Administrator. In another aspect, Blockchain Original Node 270 may include hashed data records 280. The Blockchain 260 may show the existence of the Hashed Data Records 280; however, the content may only be available to a Participant that has a key to read the hashed content. In still another aspect, Blockchain 260 may include encrypted company data 290. Similarly, data unique to a company, including Nomination data and other unique data 220,230 may be stored and available to the Off-Chain apparatus 221-222. Transaction data 240 including, by way of non-limiting example: a pipeline company, a location, and upstream designation, a Service Contract, and/or nomination identification may also be in logical communication to one or both of the Off-Chain apparatus 221-222 and the Blockchain 260.

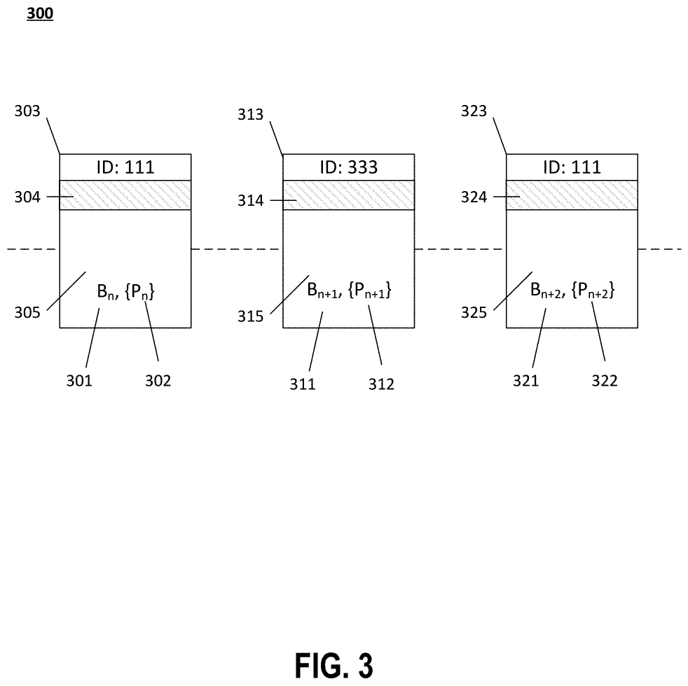

Referring now to FIG. 3, an exemplary embodiment of a subset of Blocks of a Trading Blockchain 300 is shown. The illustrated Trading Blockchain might be distributed among a marketplace (as described above) or another situation having a plurality of natural-gas trades, rather than just one trade. However, in non-illustrated embodiments, a single Trading Blockchain may be associated with a single trade between a single pair of two traders. The subset of Blocks of Trading Blockchain 300 is shown with sequential Blocks 301 311 321. A Block 301 311 321 may have a set of respective permissions 302 312 322. Permission 302 312 322 generally describes the nature of access permitted to a given Participant to the respective Block 301 311 321. For example, a permission may be set to allow all Participants to access all data on the Block (in encrypted or unencrypted fashion), ID number 303 313 323 associated with the trades reflected on the Trading Blockchain, Block cryptographic information 304 314 324 (such as a hash or a nonce), or the like.

Blocks 301 311 321 may each include information 305 315 325 about an event associated with a trade. For example, Block 301 may contain the trade details proposed by a first trader for Trade ID 111. (That the information is correlated with Trade ID 111 may be determined with reference to ID number 303.) Block 311 may include details about a separate trade, noted here as Trade ID 333, such as reconciliation information (again, with reference to ID number 313). Block 321 may include yet more details about another trade, including either of the first two trades illustrated here. Here, Block 321 is shown having information about Trade ID 111 (per ID number 323), such as a Nomination request sent to a pipeline. Even though Blocks 301 321 are related to Trade ID 111, they are not sequential in Trading Blockchain; however, the correlation with ID numbers 303 323 links the data from the two Blocks.

Information 305 315 325 encoded on the Blocks 301 311 321 may include any useful information for the execution of a natural-gas trade, including without limitation: off-Blockchain data, smart contract data (for the automatic transfer of funds following confirmation on the Trading Blockchain 300 of the transfer of natural gas), Nomination data, cut data (as may be transferred from a pipeline, and may include a reason for the cut, such as weather, non-functional pipelines, or contractual restraints), a schedule associated with a trade, volumetric data associated with a trade, confirmation that a party has received notification of a trade, resolution of reconciliation or other matters by a workflow, or other such relevant data.

In some embodiments, the information on the Blocks 301 311 321 may be encoded with a known asymmetric encryption scheme, such as RSA encryption. This would allow the entireties of all Blocks to be available to all Participants without the need for complex permissions 302 312 322. With this scheme, only the relevant Participants (i.e., the traders involved in a particular trade, the pipeline operator, and any regulatory/administrative oversight) can access the data on the specific Block by using their decryption key, while the other Participants who receive the Trading Blockchain 300 cannot access the data.

In other embodiments, a reduced amount of data may be available to all Participants as information 305 315 325. For example, in some embodiments, it may be necessary for all Participants to view certain metadata or cryptographic data 304 314 324 about a given Block 301 311 321 to verify that the Block has not been tampered with. This data could include a hash value. Accessibility of this data may be key to some of the desirable features of Blockchain technology generally, such as its immutability.

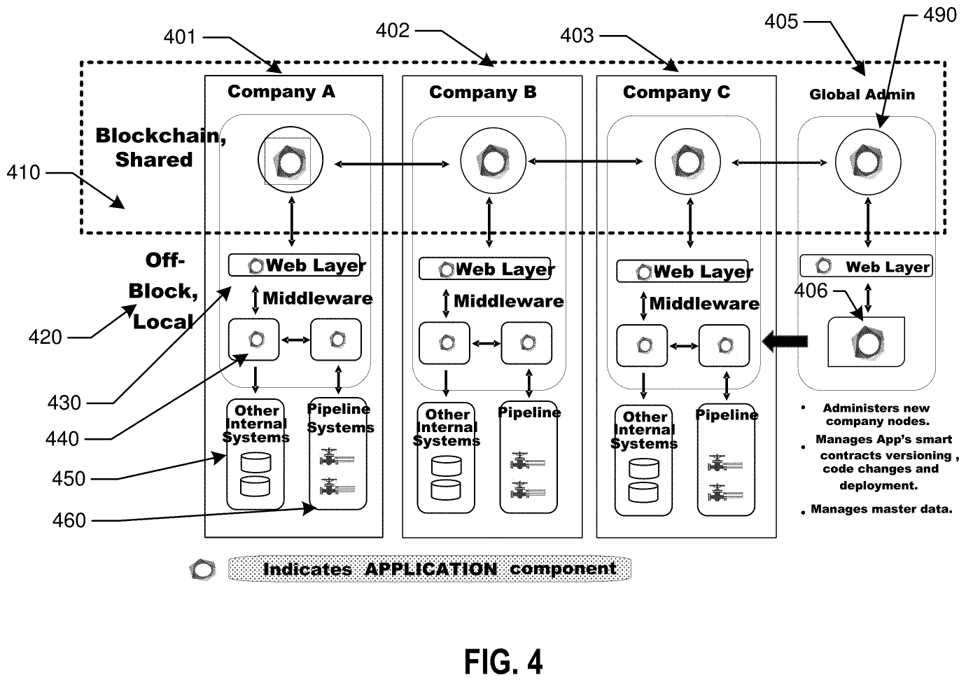

Referring now to FIG. 4, a relational block diagram of some exemplary embodiments of the present invention is illustrated. Essentially, aspects of a transaction involving a transfer of Natural Gas from a first Person, e.g., Company A 401, to a second person, e.g., Company B 402, are entered into a Blockchain 410. The Blockchain 410 may include an application component 490, and is hosted upon a controller (as discussed more fully below).

The Blockchain 410 is accessible to other Participants, such as Company C 403 and/or a Global Administrator 405. Access may be accomplished via a network access device, such as a controller, PC, or mobile smart device. For example, Company C 403 may be involved in the transport and delivery of Natural Gas involved in the transaction. The Blockchain 410 is published to Participants. According to the tenets of Blockchain management, publication provides for nonrepudiation of any given Block. However, while every Participant may possess a current copy of the Blockchain, a given Participant may not have read access to every Block, but instead may be able to access cryptographic verification information, such as a hash value, to ensure the Block has not been modified.

The Blockchain 410 is linked, such as via logical communication through digital communications, to Off-Block resources 420, 430, 440, 450, 460. The Off-Block resources 420, 430, 440, 450, 460 may include, for example, a Web Layer 430 accessible via a communications network, such as the Internet. The Web Layer 430 may in turn be connected to Middleware 440. The Middleware 440 may then be connected to other internal systems 450 or directly to pipeline systems 460. The Web Layer 430 and Middleware 440 may be unique to a particular Company 401-403 or other entity or Person.

A pipeline system 460 may be included in the aspects of Off-Block apparatus 420, 430, 440, 450, 460 that are in logical communication with the Blockchain 410. Data derived from the Blockchain may be used to initiate a transfer of gas from a first Person to a second person via the pipeline system 160.

FIG. 4 additionally illustrates a Global Administrator 405 that is a Participant and has access to the Blockchain 410. The Global Administrator 405 may be the Person responsible for code changes; addition or removal of Participants, such as company nodes; versioning of smart contracts used in conjunction with a transfer of natural gas and stored on the Blockchain 410, resolving of discrepancies in Blockchain data amongst nodes and general management of master data stored on the Blockchain 410. The Global Administrator may achieve this through proprietary software 406.

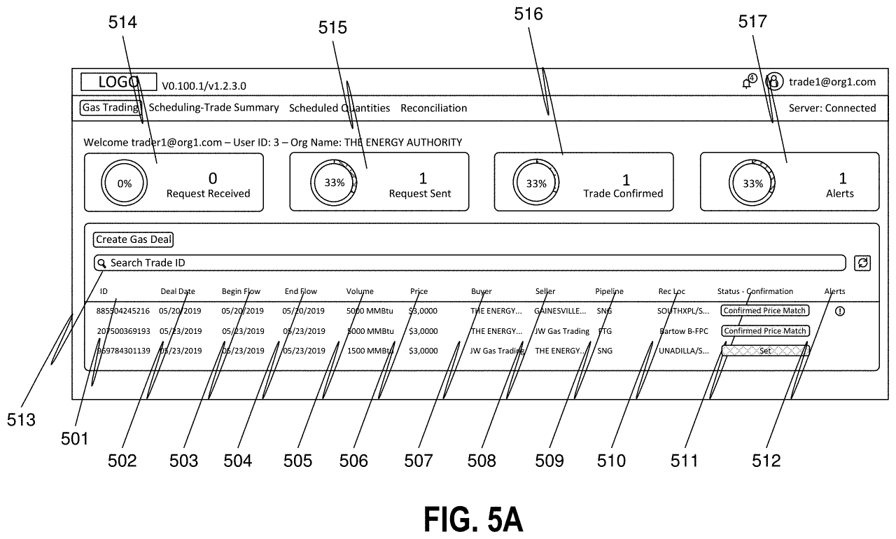

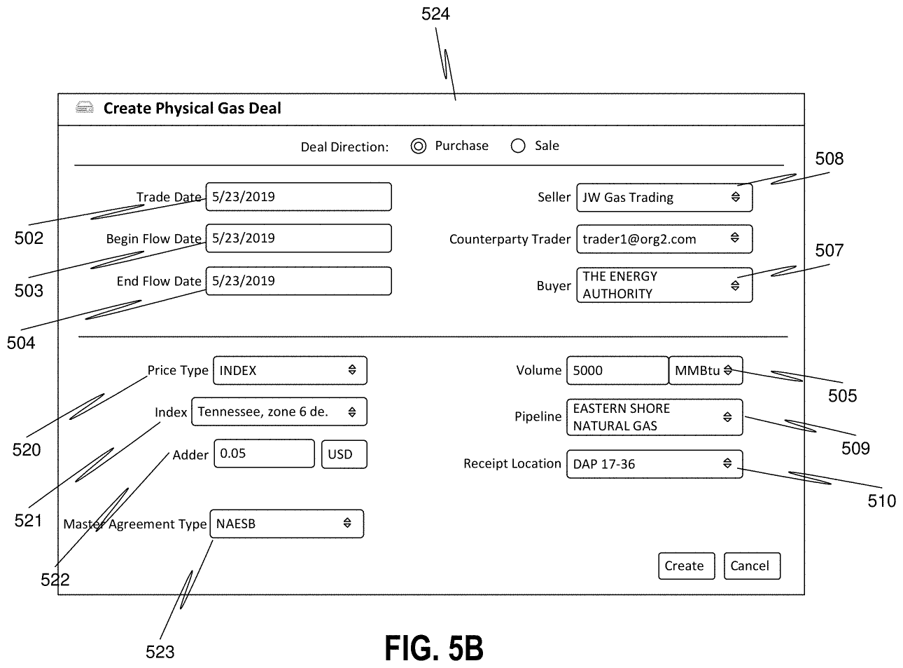

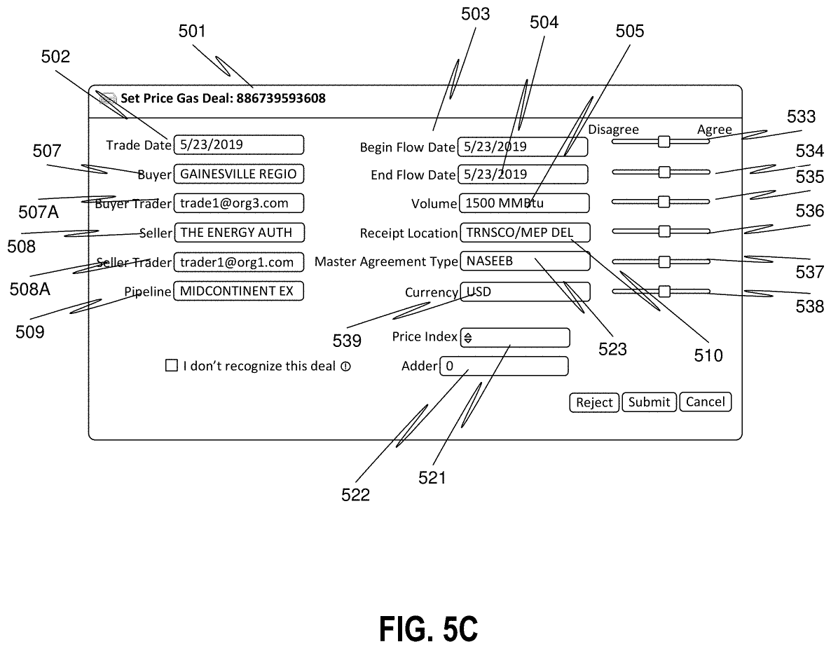

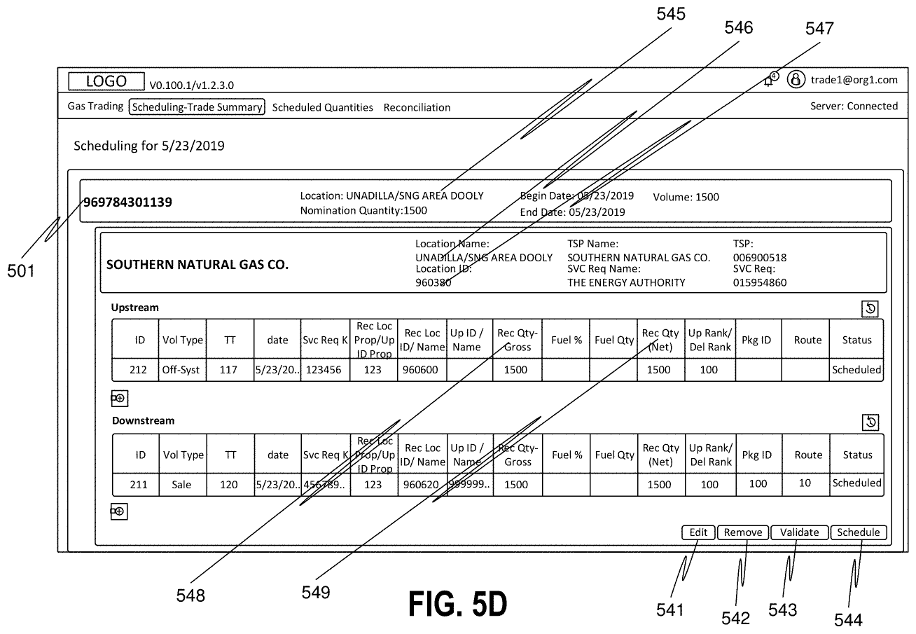

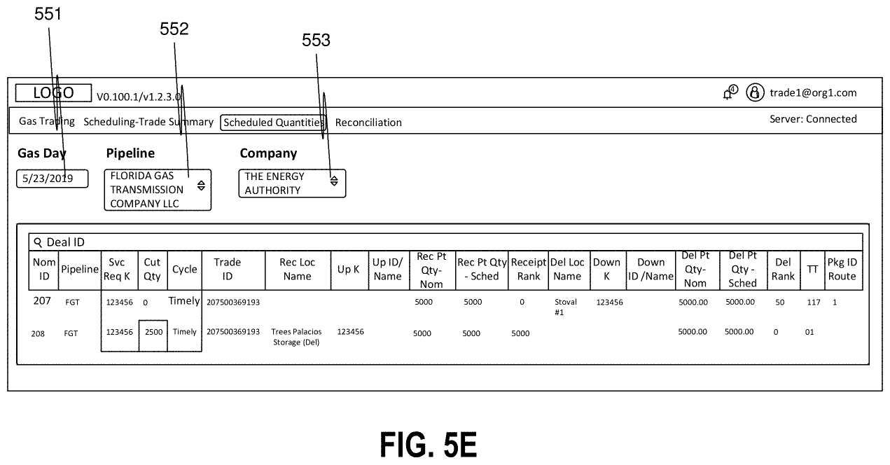

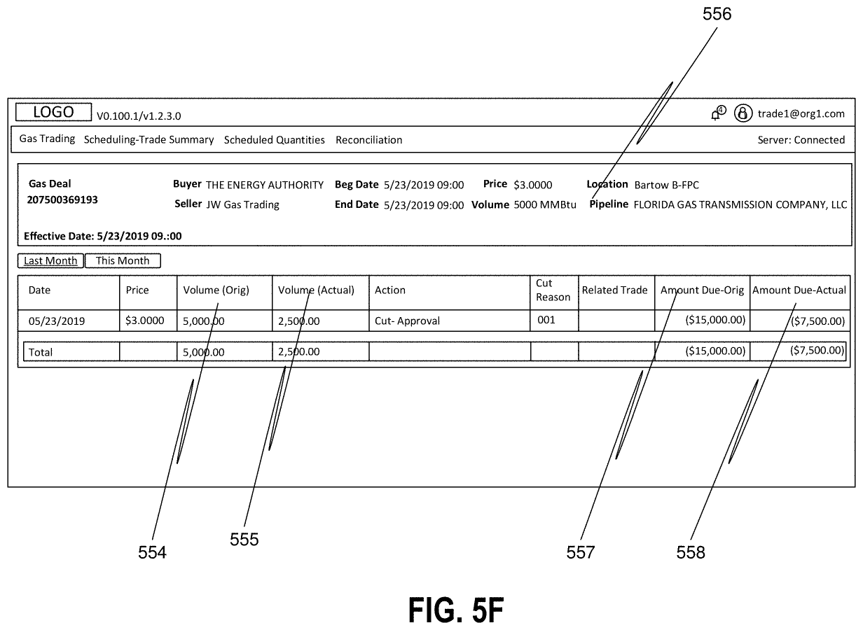

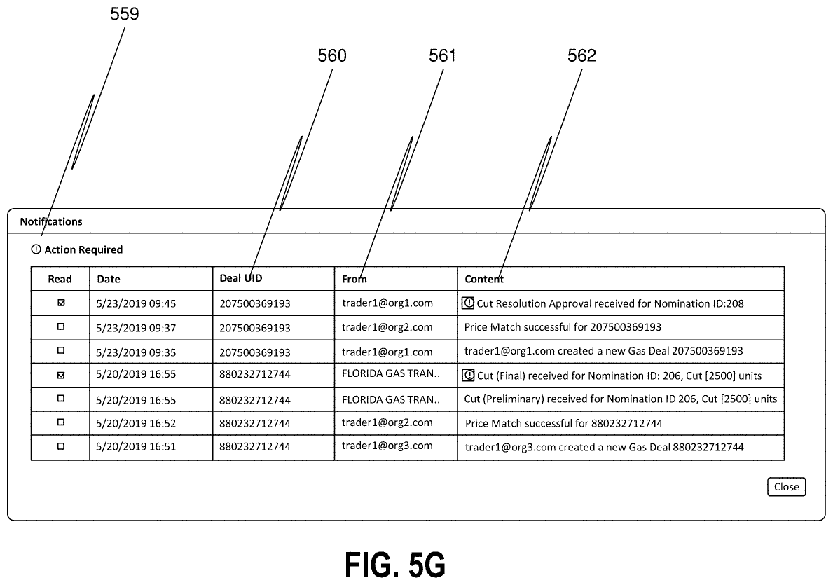

Referring now to FIGS. 5A-5G, several exemplary embodiments of a graphical user interface deployable in connection with the present invention are shown. These user interfaces may be generated based upon receipt of one or more quanta of data from one or more pipelines, physical meters, digital meters, etc. FIG. 5A shows an exemplary dashboard showing the status of trade requests, alerts, price of gas to be traded, etc. The dashboard may take information from a database in logical connection with one or more physical control mechanism or sensors. In the dashboard shown in FIG. 5A, trade ID 501 may be a unique identifier associated with a given trade. This trade may be one executed at a deal date 502. According to the parameters of the trade, natural gas flow may begin at begin flow date 503 and end at end flow date 504. At begin flow date 503, a signal may be sent to a pipeline (noted here in the dashboard as correlated with pipeline 509) to initiate a flow of natural gas via, for example, opening a valve or adjusting other volume controls. A corresponding termination signal may be sent at end flow date 504. Flow may end once the volume 505 associated with the trade has flowed through the pipeline. This flow may be measured by a flow meter or other volumetric tool. Miscalibrations in the volumetric tool may lead to the cuts and reconciliation measures discussed elsewhere herein.

Price 506 may be given in terms of a total price of the trade associated with trade ID 501 or in terms of an amount per unit volume. The total contract price may be communicated to a blockchain, smart contract, or other escrow means to automatically transfer the agreed-upon price into an escrow or from a buyer bank account to a seller bank account. Pipeline 509 may be a code representing a set of physical controls and meters associated with the given pipeline. This may assist in routing the start/stop flow commands from the dashboard to the given pipeline. Similarly, the received location 510 may represent a physical depository for the traded natural gas. This depository may have its own set of meters to confirm aspects of the natural gas trade. For example, based upon a volume meter reading at the given received location 510, a comparison may be made to the ordered volume 505 of natural gas to determine an amount of a reconciliation to be made at a subsequent time.

Other aspects of the GUI may include a status bar 511. Status bar 511 may indicate whether a set of traders have agreed upon a price for a natural gas trade. This information may be determined via a logical connection between one trader's computer servers (from whence a trade may be proposed) and another trader's computer servers (where a trade may be received and accepted, rejected, or modified). Alert indicator 512 may indicate an alert associated with the trade associated with trade ID 501, such as a need for reconciliation, a change in circumstance affecting the trade (e.g., pipeline operational difficulties), a completed trade, etc.

Still other aspects of the GUI may include a search bar 513, which may allow a user to search trades within the database by a parameter, such as a trade ID (e.g., trade ID 501). Other status indicators include received request meter 514, sent request meter 515, confirmation request meter 516, and alert meter 517 (any or all of which may be populated based on information received into a database associated with one or more traders). These meters may be expressed in either or both of: absolute numbers (e.g., total number of alerts received) or relative numbers (e.g., percentage of outstanding trades for which an active alert state exists).

FIG. 5B shows a window reflecting the creation of an individual natural-gas trade that includes information that may be imported from the dashboard of FIG. 5A, such as the buyer 507 and seller 508 of the natural gas. (Toggle 524 may allow the user to switch between initializing a purchase of the natural gas, in which case the identity of the buyer 507 may be static, or a sale of the natural gas, in which case the identity of the seller 508 of the natural gas may be static). Additional information that may be imported include the trade date 502, begin flow date 503, end flow date 504 (which, as stated previously, may have functionality allowing these dates to be transmitted to flow-control mechanisms at the chosen pipeline to initiate and terminate a transfer of natural gas), volume 505 of natural gas to be traded (and corresponding units), chosen pipeline 509 of natural gas, and receipt location 510.

This screen may also have additional functionality related to the pricing of the natural gas transaction. As shown here, one or more price types 520 may be chosen. In exemplary embodiments, the price type 520 may be tied to a certain index 521, such as NYMEX or Tennessee, zone 6 del. Based upon the chosen index 521, the database may be operative to communicate with a standardized database associated with the chosen database to determine a value of the transaction. This may be useful in situations in which a smart contract associated with the transaction uses a different type of price mechanism than the index 521, including situations in which the different price mechanism is based upon a fluctuation of index 521. (For example, a smart contract may stipulate that NYMEX will be used unless the NYMEX index fluctuates by more than 10% over the course of a given day, at which point, a different index may be used.) Adder 522 may be a modification to the index 521 price and may be transmitted to one or more smart contracts or blockchains associated with the transaction. Master agreement type 523 may give further information relating to this contract and may be linked to a separate database.

FIG. 5C illustrates another exemplary embodiment of a window relating to setting the price of a gas deal. Again, some duplicate material may be represented in this window from the other windows displayed herein, such as the trade ID 501, trade date 502, buyer 507 (and, in some embodiments, buyer contact information 507A), seller 508 (and, in some embodiments, seller contact information 508A), pipeline 509, price index 521, and adder 522. For certain types of gas trading, sliders may be deployed to indicate a level of agreement with a parameter of a natural-gas deal. If the trade details shown in FIG. 5C represent a received bid, then the sliders may allow for some negotiation. As shown here, begin flow date 503 is associated with begin flow date slider 533. The recipient of a trade proposal may slide begin flow date slider 533 to the far right to indicate that, for example, this begin flow date 503 is accepted, or to the far left to indicate that this begin flow date 503 is completely unacceptable. The slider may be transformed into a mathematical value; for example, the slider could represent a range of real numbers between −10 and +10. When submitting a counter-proposal, the number corresponding to the slider position could be transmitted to the other party to the proposal. An array of slider values may also be generated based on the slider positions of end flow date slider 534 (corresponding to end flow date 504), volume slider 535 (corresponding to volume 505), receipt location slider 536 (corresponding to receipt location 510), master agreement type slider 537 (corresponding to master agreement type 523), and currency slider 538 (corresponding to currency type 539). Algorithms may be deployed to attempt to propose one or more acceptable deals based on the respective slider values. An exemplary deal algorithm may attempt to maximize the sum of the slider values (especially where agreement is indicated by a positive number, while disagreement is indicated by a negative number).

FIG. 5D illustrates a trader-specific view of a graphical user interface in accordance with this invention, representing a scheduling or trading summary. This view displays certain Off-Block and On-Block data associated with the trader, such as the trader's upstream and downstream sales IDs, as well as trade ID 501 and trade location name 545. Functionality within the window shown in FIG. 5D may include the ability to edit 541 information about the trader (such as the trader's name, location name, location ID, service name, etc.) or to edit information about a trade associated with the trader. This window may also show information about the trader, such as the trader's location 546 and a unique location ID 547. This information may be automatically populated, manually populated, or populated by reference to some device, such as a GPS. In some embodiments, such an edit may require certain permissions, such as demonstrating an association with the trader or a global administrator. In some embodiments, editing a trade may call one of the windows shown in FIG. 5B or 5C (and thus invoke the corresponding gas-trading functionality described therein). Additionally, from the window shown, a user may be able to remove a trade, such as by canceling 542 the trade. This may cause the transmission to flow controls associated with the respective pipeline of a signal to refrain from cutting a previously designated order. Flow meters at locations associated with location ID 545 or 546 may record an amount of natural gas obtained in a trade on a gross basis 548 or a net basis 549. These amounts may be displayed on the window shown in FIG. 5D.

The user may also be able to validate 543 a trade. Validation may involve any of: transmission of a verification signal to a pipeline to ensure that the pipeline has scheduled the trade, ensuring the pipeline has a sufficient quantity of natural gas to transfer the agreed-upon volume within the agreed-upon flow dates, or initiating mechanisms within one or more smart contracts associated with the trade to ensure the trade progresses or to prompt a user to repudiate the smart contract. Additionally, the user may be able to schedule 544 a trade by transmitting a signal from the database to a server associated with the pipeline to determine one or more appropriate flow dates for a contemplated trade (based on volume, receipt location, etc.).

Similarly, FIG. 5E is a trader- and/or pipeline-specific view with Off-Block and On-Block data showing scheduled quantities of gas transfer. FIG. 5E may allow a user to sort by any of: gas day 551 (i.e., displaying some or all trades occurring on the inputted gas day 551), pipeline 552 (i.e., displaying some or all trades, whether or not occurring on the inputted gas day 551, associated with the inputted pipeline), or company (i.e., displaying some or all trades, whether or not occurring on gas day 551, associated with the inputted company, whether the company is the buyer or seller of the natural gas). In exemplary embodiments, the data displayed may include any of: nomination ID, pipeline ID, service requirement contract, amount of gas to be cut, cycle information, trade ID, location at which the natural gas will be received, upstream contract information, receiving party nomination or scheduled quantity information, ranking metadata information, downstream contract information, and package identification routes. The window in FIG. 5E may also have the editing, cancellation, validation, and scheduling functionality described in FIG. 5D. Data on this window may be generated with reference to one or more flow meters associated with pipeline 552, thus simplifying determination of the received amount of natural gas. Additionally, the Trading Blockchain or other smart contracting apparatus may be operative to determine the amount of natural gas nominated by the parties. This may be useful in determining a reconciliation process.

FIG. 5F illustrates an exemplary embodiment of a window showing a reconciliation workflow relating to a particular natural-gas trade. This window allows a Cut reason (which may be translated onto the Trading Blockchain) and elaborates on a settlement amount between the parties that may be required for reconciliation. Again, this may take and send data from and to the Trading Blockchain. An originally nominated amount volume 554 of natural gas may be determined based upon the Trading Blockchain. Based upon an agreed-upon price, index, etc., an original amount due 557 may be generated and displayed on this window. Flow meters associated with pipeline 556 may determine the amount of natural gas actually obtained 555 in the transaction. Based upon the same or different price or index, the actual amount due 558 may be determined. The difference between the original amount due 557 and the actual amount due 558 determines a reconciliation amount. This reconciliation amount, along with any of the other data displayed on this window, may be included on the Trading Blockchain. Moreover, a smart contract associated with the Trading Blockchain may be operative to make an appropriate financial account transfer from one party to the other based on the reconciliation amount. For example, the transaction shown in FIG. 5F reflects a transaction in which the original amount due 557 was $15,000 and the actual amount due 558 was $7,500. In some embodiments, the original amount due 557 may have been placed into an escrow accessible by the Trading Blockchain. (In other embodiments, funds transfers may not occur until after reconciliation.) In other embodiments, the original amount due 557 may have been transferred to the seller. The specific mechanism may depend on the specific transaction. Once the actual amount due 558 is generated, the Trading Blockchain may be operative to transfer $7,500 from the seller to the buyer, or to transfer one $7,500 payment to the seller (as the actual amount due 557) and one $7,500 payment to the buyer (as the reconciliation amount). In some embodiments, the Trading Blockchain may not make these transfers automatically if the given Cut reason is not acceptable or if a party indicates that it wishes to dispute the reconciliation amount. Accordingly, reconciliation may be simplified.

Finally, FIG. 5G shows an exemplary set of notifications for a user, including a cut notification type, a successful price-match notification, and the creation of gas deals. Action-required notification 559 may indicate to the user that the user needs to take an action. This action may be informed by the remaining elements on the screen. Deal UUID 560 may be generated and correlated with initial trade ID 501. An identity 561 of the sender or requester of an action prompting action-required notification 559 may be displayed. And action details 562 about the necessary action may also be displayed. Action details 562 may be generated with reference to one or more physical apparatus. For example, if a flow meter determines that an excess of natural gas (relative to the nominated amount) was transferred, then a notification may be sent to the user prompting the user to accept the new amount. If a Trading Blockchain receives a new block (such as a new proposed deal or a new price match), it may also cause a processor to transmit a notification to the user with details about the new trade or price match.

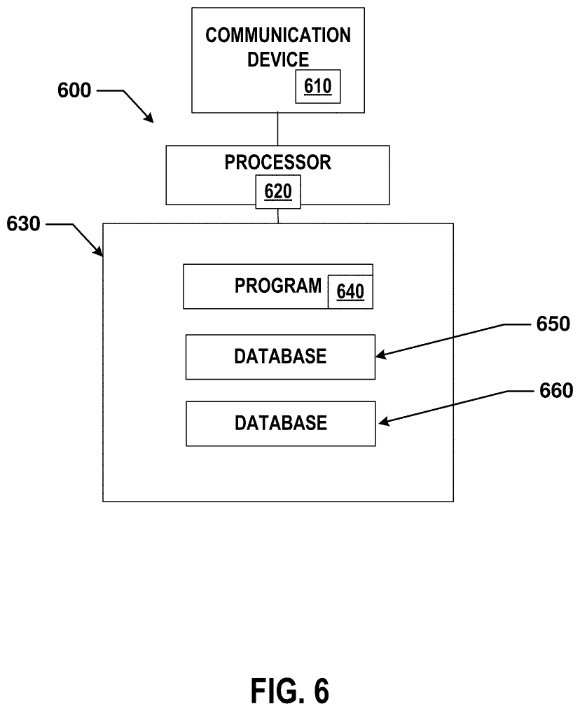

Referring now to FIG. 6, an automated controller is illustrated that may be used to implement various aspects of the present invention, in various embodiments, and for various aspects of the present invention, controller 600 may be included in one or more of: a wireless tablet or handheld device, a server, a rack mounted processor unit. The controller may be included in one or more of the apparatus described above, such as a Server, and a Network Access Device. The controller 600 includes a processor unit 620, such as one or more semiconductor-based processors, coupled to a communication device 610 configured to communicate via a communication network (not shown in FIG. 6). The communication device 610 may be used to communicate, for example, with one or more online devices, such as a personal computer, laptop, or a handheld device.

The processor 620 is also in communication with a storage device 630. The storage device 630 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 630 can store a software program 640 with executable logic for controlling the processor 620. The processor 620 performs instructions of the software program 640, and thereby operates in accordance with the present invention. The processor 620 may also cause the communication device 610 to transmit information, including, in some instances, control commands to operate apparatus to implement the processes described above. The storage device 630 can additionally store related data in a database 650 and database 660, as needed.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method for facilitating a natural-gas transaction utilizing a trading blockchain and off-block components, the method comprising the steps of:
initiating the trading blockchain comprising a plurality of blocks using a genesis block;
receiving into a computer server, which server comprises a processor, a controller, a memory, software executable on command, and which server is in logical connection with a communications network, trade details of a proposed natural-gas transaction from a first trader, wherein the trade details comprise one or more of: a quantity of natural gas to be transferred, a total price to be paid for the natural gas, a price per unit volume, a date for the proposed natural-gas transaction, a source of natural gas, and a desired number of stops for the natural gas;
appending the trade details of the proposed natural-gas transaction to the trading blockchain as a first block;
transmitting to a second trader via the communications network a notification of the proposed natural-gas transaction, wherein the notification comprises the trade details;
receiving into the computer server a confirmation of the proposed natural-gas transaction based on the trade details;
appending the confirmation of the proposed natural-gas transaction to the trading blockchain as a second block;
transmitting a nomination to a pipeline, wherein the nomination comprises the trade details;
appending the nomination to the trading blockchain as a third block;
receiving into the computer server a transfer report from the pipeline via the communications network, wherein the transfer report comprises a confirmation of a successful transfer and a cut amount, wherein the cut amount comprises an amount of natural gas delivered;
appending the transfer report to the trading blockchain as a fourth block; and
generating a reconciliation amount based upon the difference between the cut amount on the fourth block and the trade details on the first, second, or third block.

2. The method of claim 1, wherein after each step of appending a block to the trading blockchain, the trading blockchain is distributed to one or more participants, wherein the participants comprise some or all of: the first and second traders, a computer associated with the pipeline, a global administrator, a marketplace administrator, a regulator, and other entities associated with the marketplace.

3. The method of claim 2, wherein the method further comprises the step of associating a unique identifier with the natural-gas transaction, the trade details further comprise the unique identifier, and wherein each block associated with the natural-gas transaction comprises the unique identifier.

4. The method of claim 3, wherein the step of transmitting a notification to the second trader further comprises the sub-step of appending the transmission of the notification to the trading blockchain as a fifth block.

5. The method of claim 3, wherein the method further comprises the step of transmitting off-block components to one of the first and second traders, which off-block components are capable of being stored in a format other than on the trading blockchain.

6. The method of claim 5, wherein each of the blocks on the trading blockchain has associated with it a respective set of permissions, wherein each permission comprises a set of participants and respective correlated access to some or all data on the block for each respective participant.

7. The method of claim 5, wherein each permission allows all participants to access a quantum of metadata associated with a block on the trading blockchain.

8. The method of claim 3, wherein some or all data on one or more blocks is encrypted with an asymmetric encryption scheme, and further comprising the step of distributing one or more decryption keys to one or more participants.

9. The method of claim 8, wherein a decryption key for a particular block is distributed to a regulator.

10. The method of claim 8, wherein a decryption key for a particular block is distributed to a global administrator.

11. The method of claim 8, wherein a decryption key for some or all blocks associated with the natural-gas transaction is distributed to one or both of the first and second traders.

12. The method of claim 5, wherein the transmission of off-block components occurs through a web interface.

13. The method of claim 5, wherein the transmission of off-block components occurs through middleware.

14. The method of claim 3, wherein the method further comprises generating a graphical user interface capable of displaying data descriptive of the natural-gas transaction and derived from the trading blockchain.

15. The method of claim 3, wherein the method further comprises configuring smart contract protocols on the computer server capable of executing the following steps on command:
based upon data derived from the third block of the trading blockchain, electronically transferring a first amount of money associated with the price associated with the natural-gas transaction into an escrow; and
based upon data derived from the fourth block of the trading blockchain, transferring the amount of money to one of the first and second trader.

16. The method of claim 15, wherein the smart contract protocol is further operative to transfer a second amount of money from one of the first and second trader to the other of the first and second trader based upon a reconciliation amount derived from the fourth block of the trading blockchain.

17. An apparatus for controlling pipeline transfers using a trading blockchain, the apparatus comprising:
a processor;
a memory;
a controller;
a communications apparatus in logical connection with a communications network;
a storage comprising software executable on command and operable to:
initiate a trading blockchain comprising a plurality of blocks using a genesis block;
receive into the storage trade details of a proposed natural-gas transaction from a first trader, wherein the trade details comprise one or more of: a quantity of natural gas to be transferred, a total price to be paid for the natural gas, a price per unit volume, a date for the proposed natural-gas transaction, a source of natural gas, and a desired number of stops for the natural gas;
append the trade details of the proposed natural-gas transaction to the trading blockchain as a first block;
transmit to a second trader via the communications network a notification of the proposed natural-gas transaction, wherein the notification comprises the trade details;
receive into the storage a confirmation of the proposed natural-gas transaction based on the trade details;
append the confirmation of the proposed natural-gas transaction to the trading blockchain as a second block;
transmit a nomination to a pipeline, wherein the nomination comprises the trade details;
append the nomination to the trading blockchain as a third block;
receive into the storage a transfer report from the pipeline, wherein the transfer report comprises a confirmation of a successful transfer and a cut amount, wherein the cut amount comprises an amount of natural gas delivered;
append the transfer report to the trading blockchain as a fourth block; and
generate a reconciliation amount based upon the difference between the cut amount on the fourth block and the trade details on the first or second block.

18. The apparatus of claim 17, wherein the apparatus is in logical connection with a flow-control system of the pipeline and is configured to start and stop the flow of natural gas through the pipeline based on the nomination to isolate a quantity of natural gas associated with the natural-gas transaction.

19. The apparatus of claim 17, wherein the software is further operative to associate a unique identifier with the natural-gas transaction, the trade details further comprise the unique identifier, and wherein each block associated with the natural-gas transaction comprises the unique identifier.

20. The apparatus of claim 19, wherein the software is further operative to encrypt some or all data on one or more blocks with an asymmetric encryption scheme.
